(19) United States
(12) Patent Application Publication
(10) Pub. No.: US 2024/0403902 A1
(43) Pub. Date: Dec. 5, 2024

(54) COMPUTATION OF OPTIMAL RANGE OF UNIT PRODUCT VALUES

(71) Applicant: HONEYWELL INTERNATIONAL INC., Charlotte, NC (US)

(72) Inventors: Aishwarya Coffey, Dublin (IE); Himadri Pal, Sugar Land, TX (US); Lakshmi Priya Gayatri Vutukuri, Atlanta, GA (US)

(21) Appl. No.: 18/204,964

(22) Filed: Jun. 2, 2023

(51) Int. Cl. G06Q 30/0202

(52) U.S. Cl. CPC G06Q 30/0202

(57) ABSTRACT

Techniques for computing optimal range of unit product value for products having insufficient product consumption data are described. In an example, a plurality of identifiers corresponding to names of a plurality of products may be determined. Based on the plurality of identifiers, two or more clusters may be generated. Within each cluster, a first identifier associated with a product having insufficient product consumption data and a second identifier associated with a product having sufficient product consumption data is determined. Further, based on demand curve data for the product associated with the second identifier, an optimal range of a unit product value for the product associated with the first identifier is computed.

### TECHNICAL FIELD

The present subject matter relates, in general, to unit product values, and in particular but not exclusively, to computation of an optimal range of unit product value for products having insufficient product consumption data.

### BACKGROUND

With the competitive market constantly evolving, customers now have a variety of choices with respect to product values of a particular product or a particular service. Companies may optimize the product value to generate maximum profit margins. Optimization of the product value generally involves finding an optimal range of product value for a product or a service. For example, based on product details of a product, the optimal range of the product value may be determined for the product.

### SUMMARY OF INVENTION

This summary is provided to introduce concepts related computation of optimal range of unit product value for products having insufficient product consumption data. This summary is not intended to identify essential features of the claimed subject matter nor is it intended for use in determining or limiting the scope of the claimed subject matter.

In an aspect of the present subject matter, a method for computation of optimal range of unit product value for products having insufficient product consumption data is disclosed. The method includes generating two or more clusters for a plurality of products. The two or more clusters are generated by a cluster generation engine. Each of the two or more clusters have a respective set of products with similar names. The plurality of products has product consumption data with one or more data points indicating varying product consumption quantities with respect to varying unit product values for a respective product. Further, the method includes, within each cluster, for a first product having product consumption data with less than three data points, determining a second product which has product consumption data with more than three data points. In an example, the second identifier is determined by a computation engine. Based on the determination, an optimal range of a unit product value for the first product is computed by the computation engine.

In another aspect of the present subject matter, a system for computation of optimal range of unit product value for products having insufficient product consumption data is disclosed. The system includes a processor, a cluster generation engine, and a computation engine. The cluster generation engine and the computation engine, both are coupled to the processor. The cluster generation engine determines a plurality of identifiers which corresponds to names of a plurality of products. The plurality of products having product consumption data with one or more data points indicating varying product consumption quantities with respect to varying unit product values for a respective product. Further, the cluster generation engine generates two or more clusters for the plurality of identifiers. Each of the two or more clusters has a respective set of identifiers from amongst the plurality of identifiers. The set of identifiers relates to products with similar names. The computation engine determines a second identifier associated with product consumption data having more than three data points for a first identifier associated with product consumption data having less than three data points, within each of the two or more clusters. The determination is based at least in part on a distance between the first identifier and the second identifier. Further, on the basis of said determination, an optimal range of a unit product value is computed for a product associated with the first identifier.

In yet another aspect of the present subject matter, a non-transitory computer-readable medium for computation of optimal range of unit product value for products having insufficient product consumption data is disclosed. The non-transitory computer-readable medium has instructions stored thereon. The instructions, when executed by a processor, cause the processor to perform operations. In the operations, identifiers corresponding to names of a plurality of products are generated. The plurality of products having product consumption data with one or more data points which are indicative of varying product consumption quantities with respect to varying unit product values for a respective product. Further, the identifiers are clustered into an optimal number of clusters. The clustering is based on a similarity in the names of the plurality of products. Within each cluster, a pair of identifiers is determined which are closest to each other and have a variation in product values within a pre-defined limit. A first identifier from the pair of identifiers relates to a product having product consumption data with less than three data points and a second identifier from the pair of identifiers relates to a product having product consumption data with more than three data points. Further, an optimal range of a unit product value for the product associated with the first identifier is computed based on demand curve data pertaining to the product associated with the second identifier. The demand curve data is indicative of product consumption quantities with respect to the varying unit product values.

### BRIEF DESCRIPTION OF FIGURES

Systems and/or methods, in accordance with examples of the present subject matter are now described and with reference to the accompanying figures, in which:

FIG. 1 illustrates a system for computing optimal range of unit product value for products having insufficient product consumption data, according to an example;

FIG. 2 illustrates a network environment for computing an optimal range of unit product value for product having insufficient product consumption data, according to an example;

FIG. 3 illustrates an elbow graph for computing an optimal range of unit product value for product having insufficient product consumption data, according to an example;

FIG. 4 illustrates a schematic representation of a cluster for computing an optimal range of unit product value for product having insufficient product consumption data, according to an example;

FIG. 5 illustrates an exemplary table indicating a cluster group for computing an optimal range of unit product value for product having insufficient product consumption data, according to an example;

FIG. 6 illustrates a screenshot listing products having sufficient product data corresponding to products having insufficient product data for computation of optimal range of unit product value for products having insufficient product consumption data, according to an example;

FIG. 7 illustrates a method for computing an optimal range of unit product value for products having insufficient product consumption data, according to an example;

FIG. 8 illustrates a method for computing an optimal range of unit product value for products having insufficient product consumption data, according to an example; and

FIG. 9 illustrates a non-transitory computer readable medium for computing optimal range of unit product values for products having insufficient product consumption data, according to an example.

### DETAILED DESCRIPTION

With the ever-evolving market of products (for example, cryocoolers, transponders, transducers, etc.) or services, market competition may also change. As a result, customers may be provided with a variety of choices for a particular product as per their requirements. This may affect the demand for the product or the service. To accommodate such situations, companies may optimize unit products of the product or service. A unit product value of a product may be indicative of a selling amount associated with the product. To optimize the unit product value, a range of the unit product value is identified for the product at which the profitability may be maximized.

The optimal range of the unit product value for a product with sufficient product consumption data can be determined by creating a demand curve. For example, the product consumption data may include data related to sale of a product, for example, selling quantities of the product, demand of the product, selling amount of the product, discount on the product, etc. The demand curve typically provides a graphical relationship between the number of units sold and the unit product value of a product, within a specific time frame. For example, a demand curve generated for one year time frame may indicate that as the unit product value goes up, quantity demanded reduces and as the unit product value reduces quantity demanded increases. The demand curve is generated based on historical data related to consumption of the product. The demand curve facilitates in determining an optimal range of the unit product value for the product. However, for products having insufficient product consumption data, i.e., not enough sales, the demand curve may not be generated. Therefore, an optimal price range for the product or the service having insufficient product consumption data may not be obtained.

The present subject matter provides approaches for computing an optimal range of unit product value for products having insufficient product consumption data. In an example, the present subject matter discloses obtaining names of a plurality of products. The names of the plurality of products may be transformed into numerical values or identifiers, such as by using Natural Language Processing (NLP) techniques. The identifiers associated with names of the plurality of products may be grouped into different clusters, such as by using K-means clustering method. K-means clustering involves clustering data points (identifiers) based on similar properties. In the present subject matter, the clustering is performed on the basis of similarity in names of the products. Within each cluster, for a product having sufficient product consumption data another product having insufficient product consumption data, is determined. In an example, the determination is based on a distance between the identifiers associated with the products. In another example, in addition to the distance, the determination is based on a variation in the unit product value of the two products. For example, if the variation in the unit product value of the product with sufficient product consumption data and the product with insufficient product consumption data is about 25%, the two products may be mapped together. This process is performed for all such products having insufficient product consumption data, thereby mapping products having insufficient product consumption data to products having sufficient product consumption data. Thereafter, demand curve data pertaining to the product with sufficient product data is obtained. Based on the demand curve data, the optimal range of unit product value for products having insufficient product consumption data is computed.

Accordingly, the present subject matter facilitates in generating revenues for the products with insufficient product consumption data. In addition, the present subject matter relies on the information available for those products which have sufficient product consumption data and demand curve data. Thus, the present subject matter does not require additional resources for collation of product consumption data.

As used hereinafter, the terms “comprises,” “comprising,” “includes,” “including,” “has,” “having” and any other variation thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

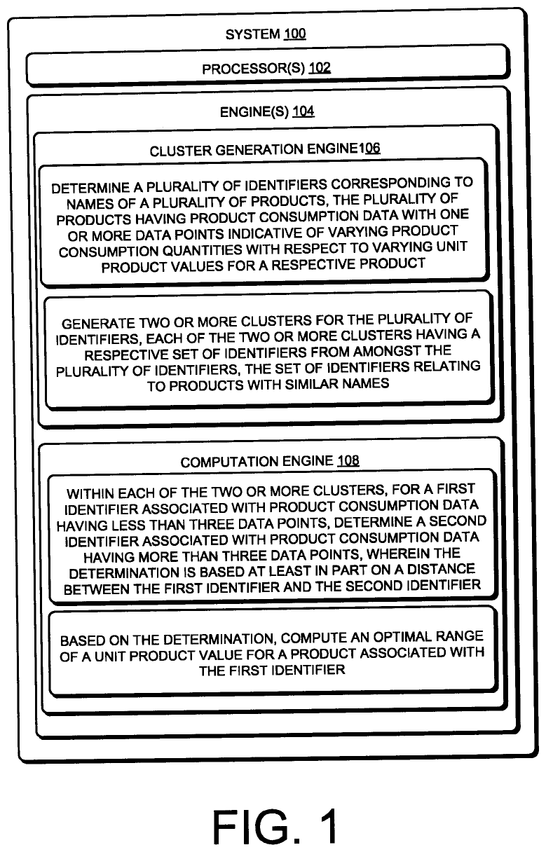

FIG. 1 illustrates a system 100 for computing optimal range of unit product value for products having insufficient product consumption data, according to an example. The product consumption may include data related to sale related of the product, for example, selling quantities of the product, demand of the product, selling amount of the product, discount on the product, etc. In an example, the unit product value may be indicative of a unit selling amount of the product. Examples of the system 100 may include, but are not limited to, a laptop, a notebook computer, a tablet computer, and a smartphone. The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 104 may be implemented as electronic circuitry. The engine(s) 104 includes a cluster generation engine 106 and a computation engine 108.

In operation, the cluster generation engine 106 of the system 100 may determine a plurality of identifiers corresponding to names of a plurality of products. The plurality of products having product consumption data with one or more data points. For example, the plurality of products may include those products which have sufficient product consumption data, i.e., three or more data points as well as those products which have insufficient product consumption data, i.e., less than three data points. The data points of product consumption data for the plurality of products indicate varying product consumption quantities with respect to varying unit product values for a respective product.

In an example, the identifiers may indicate numerical representation of the names of the plurality of products. To this end, the cluster generation engine 106 may employ natural language processing techniques for determining the identifiers corresponding to names of the plurality of products. Further, the cluster generation engine 106 may generate two or more clusters for the plurality of identifiers. Each of the two or more clusters has a respective set of identifiers from amongst the plurality of identifiers. The respective set of identifiers relate to products with similar names. For example, the plurality of products may include a first product named as “DAMPER ACTUATOR 10 NM 24 V FLT SWITCH” and a second product named as “DAMPER ACTUATOR 20 NM 24 V FLT SWITCH”. Based on the product names of the first product and the second product, the cluster generation engine 106 may determine an identifier corresponding to each product. As there is similarity in the names of the first product and the second product, the cluster generation engine 106 may cluster the respective identifiers together in the same cluster.

Once the clusters are generated, within each of the two or more clusters, the computation engine 108 of the system 100 may identify a first identifier associated with a product having product consumption data having less than three data points. In other words, the first identifier may be associated with a product having insufficient product consumption data. Further, for the first identifier, the computation engine 108 may determine a second identifier. The second identifier may be associated with a product having product consumption data having more than three data points. In other words, the second identifier may be associated with a product having sufficient product consumption data.

In an example, to determine the second identifier for the first identifier, the computation engine 108 may at least determine a distance between the first identifier and the second identifier. For example, for every identifier of a product with insufficient product consumption data, the computation engine 108 may determine a second identifier of a product with sufficient product consumption data, which is closest to the first identifier.

Based on the determination, the computation engine 108 may compute an optimal range of a unit product value for the product associated with the first identifier. In an example, based on the determination of the second identifier, the computation engine 108 may obtain demand curve data for the product associated with the second identifier. Based on the demand curve data, the computation engine 108 may compute the optimal range of the unit selling price for the product having insufficient product consumption data.

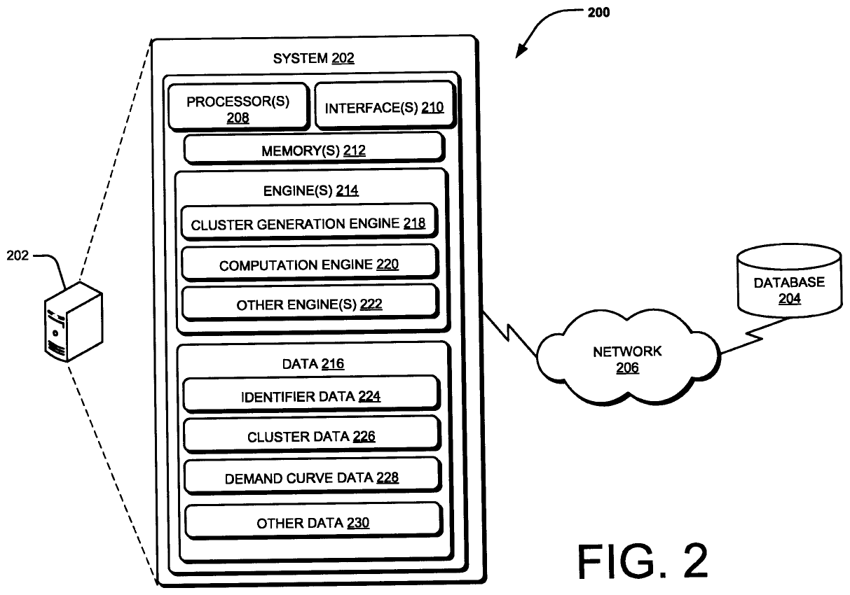

FIG. 2 illustrates a network environment 200 for computing an optimal range of unit product value for product having insufficient product consumption data, according to an example. The network environment 200 includes a system 202 for computing an optimal range of unit product value for product having insufficient product consumption data. The system 202 is similar to the system 100. In an example, the system 202 may be connected to a database 204 through a network 206. The network 206 may be a wireless network, a wired network, or a combination thereof. The network 206 can also be an individual network or a collection of many such individual networks, interconnected with each other and functioning as a single large network, e.g., the Internet or an intranet. The network 206 can be implemented as one of the different types of networks, such as intranet, local area network (LAN), wide area network (WAN), the internet, and such. The network 206 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one implementation, the network environment 200 can be a company network, including thousands of office personal computers, laptops, various servers, such as blade servers, and other computing devices connected over the network 206. The system 202 includes processor(s) 208 similar to the processor(s) 102. Further, the system 202 includes interface(s) 210 and memory(s) 212. The interface(s) 210 may allow the connection or coupling of the system 202 with one or more other devices, through a wired (e.g., Local Area Network, i.e., LAN) connection or through a wireless connection (e.g., Bluetooth®, Wi-Fi). The interface(s) 210 may also enable intercommunication between different logical as well as hardware components of the system 202.

The memory(s) 212 may be a computer-readable medium, examples of which include volatile memory (e.g., RAM), and/or non-volatile memory (e.g., Erasable Programmable read-only memory, i.e., EPROM, flash memory, etc.). The memory(s) 212 may be an external memory, or internal memory, such as a flash drive, a compact disk drive, an external hard disk drive, or the like. The memory(s) 212 may further include data which either may be utilized or generated during the operation of the system 202.

The system 202 may further include engine(s) 214 and data 216. The engine(s) 214 includes a cluster generation engine 218, a computation engine 220, and other engine(s) 222. The other engine(s) 222 may further implement functionalities that supplement functions performed by the system 202 or any of the engine(s) 214. The data 216, on the other hand, includes data that is either stored or generated as a result of functions implemented by any of the engine(s) 214 or the system 202. It may be further noted that information stored and available in the data 216 may be utilized by the engine(s) 214 for performing various functions by the system 202. In an example, the data 216 may include identifier data 224, cluster data 226, demand curve data 228, and other data 230. It may be noted that such examples are only indicative. The present approaches may be applicable to other examples without deviating from the scope of the present subject matter.

In operation, the cluster generation engine 218 of the system 202 may determine a plurality of identifiers corresponding to names of a plurality of products. The plurality of products having product consumption data with one or more data points indicative of varying product consumption quantities with respect to varying unit product values for a respective product. The unit product value may be indicative of the selling amount per unit of the product. The cluster generation engine 218 may obtain information pertaining to the plurality of products, such as names of the products, data points associated with each of the plurality of products, from the database 204.

In an example, the cluster generation engine 218 may employ natural language processing (NLP) techniques to determine the plurality of identifiers. The plurality of identifiers enables the system 202 to apply machine learning models using the cluster generation engine 218 to determine the optimal range of unit product value for products with insufficient product consumption data. For example, the cluster generation engine 218 may convert names of each of the plurality of products in lowercase. Further, the cluster generation engine 218 may remove punctuations and stopwords from the names of each of the plurality of products. For example, before employing the natural language processing techniques, the cluster generation engine 218 may filter out words, such as (a, the, is, are), which are common and do not add much information to the text.

Once the product names are converted into plain text, the cluster generation engine 218 may employ a natural language processing (NLP) tool, such as Sentence Transformer Package, to determine the identifiers for each of the plurality of product names. The identifiers may be understood as numerical values or numerical representations associated with names of each of the plurality of products. In an example implementation, the cluster generation engine 218 may employ a vectorization technique to determine the identifiers. In an example, the identifiers may be in the form of arrays or tensors. For example, the vectorization technique may be Bag of Words (BoW) vectorization and Term frequency-inverse document frequency (tf-idf) vectorization. Although some of the transformation techniques are listed here, a plurality of other techniques may also be applied to transform the names of the products into identifiers. In an implementation, the cluster generation engine 218 may store the identifiers as the identifier data 224.

After determining the plurality of identifiers, the cluster generation engine 218 may determine an optimal number of clusters in which the plurality of identifiers is to be clustered. In an example, the cluster generation engine 218 may employ an elbow method to determine the optimal number of clusters in which the plurality of identifiers is to be clustered. In an implementation, the cluster generation engine 218 may define different number of clusters (say 50, 100, 250, and so on). Thereafter, the cluster generation engine 218 may calculate sum of a squared distance between an identifier and a centroid for each number of cluster. Based on the squared distance, the cluster generation engine 218 may determine the optimal number of clusters.

Upon determining the optimal number of clusters, the cluster generation engine 218 may generate two or more clusters for the plurality of identifiers. Each of the two or more clusters having respective set of identifiers from the plurality of identifiers. For example, the cluster generation engine 218 may employ a K-means clustering technique to cluster the plurality of identifiers based on similar characteristics. In the present implementation, the optimal number of clusters is provided as an input to the cluster generation engine 218. Based on the input, the cluster generation engine 218 may generate the two or more clusters based on similarity in the names of the products. As mentioned earlier, the products having similar names may also have similar identifiers, therefore, each of the two or more clusters may include set of identifiers relating to products with similar names. In an implementation, the cluster generation engine 218 may store information pertaining to the clusters as the cluster data 226.

In an example, the cluster generation engine 218 may employ the K-means clustering to assign a set of identifiers to a cluster such that within the cluster, the sum of the squared distance (SSD) between the identifiers and a centroid of the cluster is at the minimum. In the present example, the centroid of the cluster is indicative of a mean position of the identifiers in the cluster. Although described in context of squared distance, the distance may be Euclidean distance, Manhattan distance, Minkowski distance, Hamming distance, and so on.

Once the clustering is performed, the computation engine 220 of the system 202 may, within each cluster, identify a first identifier associated with a product having product consumption data having less than three data points. In other words, the first identifier may be associated with a product having insufficient product consumption data. Further, for the first identifier, the computation engine 220 may determine a second identifier, within the same cluster. The second identifier may be associated with a product having product consumption data having more than three data points. In other words, the second identifier may be associated with a product having sufficient product consumption data.

In an implementation, to determine the second identifier for the first identifier, the computation engine 220 may at least determine a distance between the first identifier and the second identifier. For example, for every identifier of a product with insufficient product consumption data, the computation engine 220 may determine a second identifier of a product with sufficient product consumption data, which is closest to the first identifier. For example, the computation engine 220 may determine a root mean square distance between the first identifier and the second identifier. In the present example, the distance between the first identifier and the second identifier may also be one of a Manhattan distance, Hamming distance, Minkowski distance and so on.

In another implementation, the computation engine 220 may determine the second identifier based on a unit product value of the first identifier and the second identifier. The computation engine 220 may determine a pre-defined variation in a unit product value of a first product associated with the first identifier and a unit product value of a second product associated with the second identifier. In an example, the computation engine 220 may obtain information pertaining to price or unit product values of different products from the database 204. If the variation in the unit product value of the first product and the second product is within a pre-defined range, such as 25%, the computation engine 220 may select the identifier associated with the second product as the second identifier.

For example, the cluster may include an identifier for a first product named as “DIFFERENTIAL PRESSURE SWITCH, 40˜400PA” and an identifier for a second product named as “DIFFERENTIAL PRESSURE SWITCH, 200˜1000PA”. The computation engine 220 may compare a unit price for the first product with a unit price for the second product. For example, if the unit price for the first product is USD 100 and for the second product is USD 90, i.e., has a variation of less than 25%, the computation engine 220 may map the identifier of the first product with the identifier of the second product.

Based on the determination, the computation engine 220 may compute an optimal range of a unit product value for the product associated with the first identifier. In an example, based on the determination of the second identifier, the computation engine 220 may obtain demand curve data for the product associated with the second identifier. In an example, demand curve data is indicative of sales quantities or product consumption quantities with respect to the varying unit product values. The computation engine 220 may obtain the demand curve data from the database 204. Further, the computation engine 108 may compute a slope from the demand curve data of the second product. The slope may determine variation in product consumption quantities with respect to the unit product values for a particular product. In an example, based on the slope, an optimal range of unit product value for the product with insufficient product consumption data may be determined to have high selling quantities of the product. In an example, the optimal range may be defined as unit product value−X % to unit product value+Y %, wherein the X % and Y % may be optimized based on the slope of the product consumption data.

In an alternate implementation, the computation engine 220 may retrieve pre-defined categories associated with slopes of demand curves pertaining to products having sufficient product consumption data. In an example, the pre-defined categories are retrieved from the database 204. The pre-defined categories may include five categories of demand curves based on the slope. The computation engine 220 may compare the slope of the second product with the pre-defined categories. Based on the comparison, the computation engine 220 may identify a pre-defined category in which the slope of the second product fits in. In addition, based on the identification, the computation engine 220 may determine on optimal range of the unit product value for the first product based on a range of the unit product value of the identified pre-defined category.

The present subject matter therefore facilitates mapping products having insufficient product consumption data with the products having sufficient product consumption data. As a result, an optimal range of product value for products with insufficient product consumption data may be obtained with accuracy. Based on the optimal price range, an entity (company or business unit) may revise strategies pertaining to sales of the products and services to maximize profit, revenue, volume, or to achieve other business goal(s). As the present subject matter relies on the product consumption data of products having three or more data points, additional resources are not utilized for data mining.

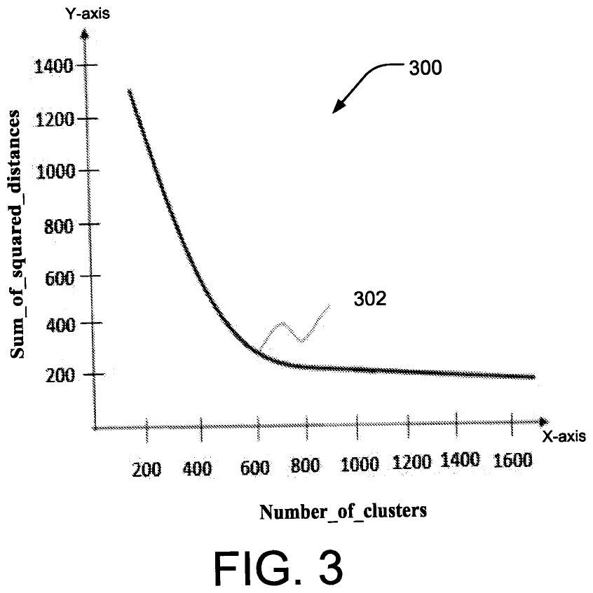

FIG. 3 illustrates an elbow graph 300 for computing an optimal range of unit product value for product having insufficient product consumption data, according to an example. As mentioned above, the system 202 employs the elbow method to determine a number of clusters in a data set. In the present subject matter, considering the data set to include a plurality of identifiers, the cluster generation engine 218 may generate the elbow graph 300. The elbow graph 300 depicts the number of clusters on the X-axis and a sum of square distances of the identifiers from a centroid within varying number of clusters on Y-axis.

As may be seen from the elbow graph 300, the sum of square distances decreases with an increase in the number of clusters. The cluster generation engine 218 may identify a bend or “elbow” 302 in the elbow graph 300. The bend 302 indicates a region when the sum of square distances drastically changes and tends to become constant with respect to the number of clusters. In the present elbow graph 300, the bend 302 occurs when the number of clusters is “600”. Thus, the elbow graph 300 indicates that the number of clusters in which the plurality of identifiers is to clubbed is “600”. Although the present subject matter has been described with reference to an elbow method, other methods, such as Silhouette method, for determining optimal number of clusters may be employed.

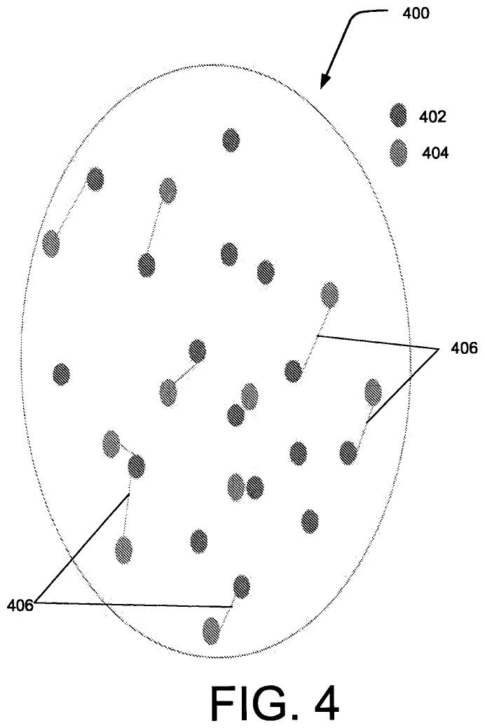

FIG. 4 illustrates a schematic representation of a cluster 400 for computing an optimal range of unit product value for product having insufficient product consumption data, according to an example. The cluster 400 is obtained after applying K-means clustering on a plurality of products for which the optimal number of clusters has been determined using elbow method as illustrated in FIG. 3. Once the clusters are generated, within each cluster, such as the cluster 400, the computation engine 220 may identify an identifier 402 representing a product with insufficient product consumption data. For the identifier 402, the computation engine 220 may determine another identifier 404 representing a product with sufficient product consumption data.

Thereafter, the computation engine 220 may compute a distance 406 between the identifier 402 and the identifier 404. In the present implementation, the distance 406 may be a root mean square distance. In other examples, the distance may also be Manhattan distance, Minkowski distance, Hamming distance and so on. In addition, the computation engine 220 may also determine a variation in the unit product value for the product associated with the identifier 402 and the product associated with the identifier 404. When the distance 406 between the identifier 402 and the identifier 404 is the shortest and the variation in the unit product value is within 25%, the computation engine 220 may form a pair of the identifiers 402 and 404, within each cluster. Thereby, products with insufficient data are mapped on to products having sufficient product consumption data, within a cluster.

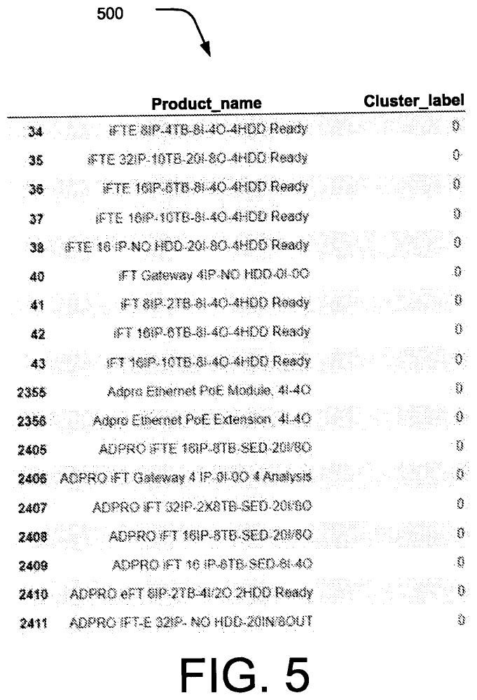

FIG. 5 illustrates an exemplary table 500 indicating a cluster group, for computing an optimal range of unit product value for product having insufficient product consumption data, according to an example. The table 500 includes a plurality of products under the column “Product_name”. The plurality of products is clustered into a cluster group defined under the column “cluster_label”. The table 500 depicts a cluster and the products clubbed in the cluster, such as by using a K-means clustering technique. As shown in FIG. 5, products with different serial numbers are clustered into a cluster label as “0”. As explained earlier, products having similar names are put together in the same cluster. Accordingly, FIG. 5 illustrates products having similar names listed in the cluster. Based on the arrangement of the products, the computation engine 220 may form pairs of the similar named products to determine the optimal range of unit product value for the product with insufficient product consumption data.

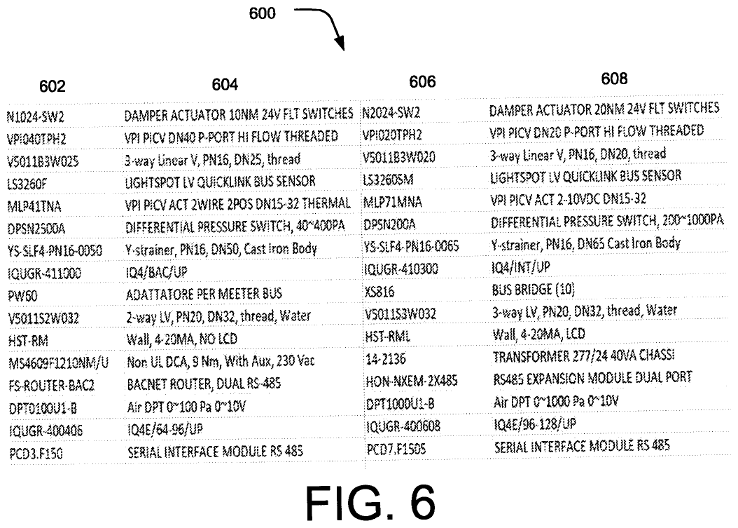

FIG. 6 illustrates a snapshot 600 listing products having sufficient product consumption data corresponding to products having insufficient product consumption data for computation of optimal range of unit product value for products having insufficient product consumption data, according to an example. The snapshot 600 is obtained as a result of actions performed by the cluster generation engine 218 and the computation engine 220. As depicted in the snapshot 600, column 604 indicates names of products which have insufficient product consumption data, i.e., product consumption data having less than three data points. Further, column 602 indicates identifiers or numerical representations associated with each product from column 604. Likewise, column 608 indicates names of products which have sufficient product consumption data, i.e., product consumption data having three or more data points. Further, column 606 indicates identifiers or numerical representations associated with each product from column 608. Thus, upon determining the shortest distance and price variation between the products of column 604 and 608, the computation engine 220 may generate a table based on which the snapshot 600 is obtained.

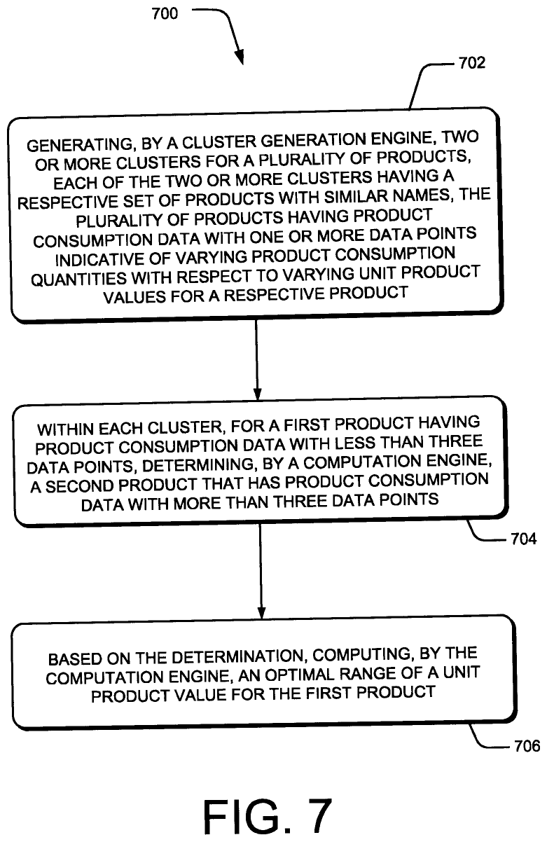

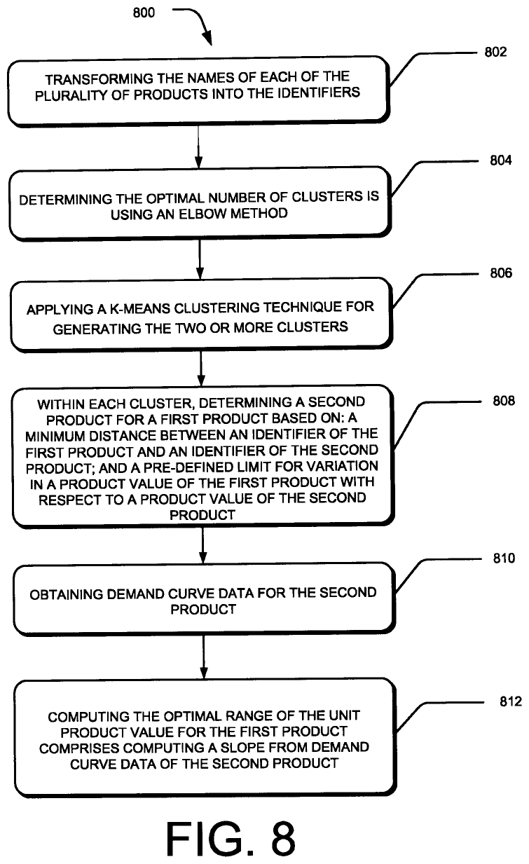

FIGS. 7 and 8 illustrate methods 700 and 800 for computing an optimal range of a unit product value for products having insufficient product consumption data, according to an example. The order in which the above-mentioned methods are described is not intended to be construed as a limitation, and some of the described method blocks may be combined in a different order to implement the method, or an alternative method.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where said instructions perform some or all the steps of the above-mentioned methods.

Referring to FIG. 7, the method 700 may be implemented by a system for computing an optimal range of unit product value for products having insufficient product consumption data. At block 702, the method includes generating two or more clusters for a plurality of products. Each of the two or more clusters have a respective set of products with similar names. Further, the plurality of products have product consumption data with one or more data points. The data points may be indicative of varying product consumption quantities with respect to varying unit product values for a respective product. In an example, before generating the clusters, names of the plurality of products is transformed into numerical values or identifiers. For instance, the method 700 includes transforming the names of the plurality of products into identifiers using natural language processing techniques. In an implementation, the two or more clusters are generated by the cluster generation engine 218.

At block 704, the method 700 includes, within each cluster, for a first product having product data less than three data points, determining a second product that has product data with more than three data points. As described above, the cluster generation engine 218 may generate clusters of identifiers that belong to products having similar names. Within each cluster, the computation engine 220 may determine for a first identifier associated with the first product a second identifier, associated with the second product. For example, the computation engine 220 measures distance between the first identifier and the second identifier as shown in FIG. 4.

Further, at block 706, the method 700 includes computing an optimal range of unit product value for the first product, based on the determination. In an example, the computation engine 220 may compute the optimal range of unit product value. For instance, the computing engine 220 may retrieve demand curve data for the second product and based on the demand curve data, identify the optimal range of unit product value for the first product.

Further, at block 706, the method 700 includes computing an optimal range of unit product value for the first product, based on the determination. In an example, the computation engine 220 may compute the optimal range of unit product value. For instance, the computing engine 220 may retrieve demand curve data for the second product and based on the demand curve data, identify the optimal range of unit product value for the first product.

Referring now to FIG. 8, at block 802, the method 800 includes transforming names of all products into identifiers. In an implementation, the cluster generation engine 218 may transform the names of the products. In an example, the method 800 employs using natural language processing (NLP) techniques to transform the names of all the products into identifiers. In an example, the identifiers are indicative of numerical representations of the names of the products. The NLP techniques involve transforming natural language (text such as names of the products) into numerical representations which are distinct from each other. For example, the transformation may be performed by vectorization. In an example, the identifiers may be arrays or tensors. The process of transforming names of the products into identifiers may include removal of stopwords such as (a, the, is, are), punctuations, and using lowercase representation of the names which are fed to a NLP tool, such as, Sentence Transformer Package, that may work on text vectorization techniques, such as, Bag of Words (BoW) vectorization and Term frequency-inverse document frequency (tf-idf) vectorization. Although some of the transformation techniques are listed here, a plurality of other techniques may also be used in NLP based transforming process for transforming names of the products into numerical values. The identifiers therefore represent an unlabeled data set of products or services. The unlabeled data set includes products having sufficient product consumption data (more than three data points) and products with insufficient product consumption data (less than three data points). In an example, the clustering technique may be applied based on similarity in the names of the products (thereby similarity in the identifiers of the products). Clustering may indicate grouping of unlabeled data into groups having elements with similar characteristics. Such groups are referred to as clusters.

At block 804, the method 800 may include determining an optimal number of clusters using elbow method. An elbow method employs an elbow graph which represents a relationship between sum of the squared distance (SSD) of data points present within the cluster and the cluster's centroid with respect to increasing number of clusters. The elbow graph depicts number of clusters on X-axis and SSD on Y-axis. An exemplary relation between the SSD and number of clusters is depicted in FIG. 3. The number of clusters are varied and for each value of cluster, SSD is calculated by the cluster generation unit. Generally, the SSD decreases with the increase in number of clusters. At a certain number of clusters, the SSD rapidly changes and the changes then becomes almost constant. Such a number of clusters is regarded as the optimal number of clusters. In an example, the optimal number of clusters is determined by the cluster generation engine 218.

At block 806, the method 800 includes applying K-means clustering technique for generating two or more clusters. In an example, the cluster generation engine 218 may apply the K-means clustering technique using the optimal number of clusters. K-means clustering includes assigning data points to a cluster such that the sum of the squared distance (SSD) between the data points and a cluster's centroid (arithmetic mean of all the data points belonging to the cluster) within a cluster is at the minimum. Based on the optimal number of clusters, the K-means clustering is applied on the identifiers. The distance of the identifiers from the nearest centroid is calculated. The distance may be Euclidean distance or Manhattan distance. Other distances, for example, Minkowski distance or Hamming distance may also be used. Thereafter, the identifiers are assigned to that nearest cluster centroid, thereby creating new clusters. Based on the new clusters, the positions of centroids are re-calculated. The K-means clustering is iterated until the position of the centroid becomes almost constant, thereby attaining full convergence. Hence, two or more clusters for the plurality of products are generated. Each of the clusters have a respective set of products with similar names.

At block 808, the method includes determining, within each cluster, a second product having product consumption data with more than three data points (sufficient data) for a first product having product consumption data with less than three data points (insufficient data). The product consumption data of the first and second products may be sale related details of the first and second products, for example, selling quantities, demand, prices, etc., of the first and second products. In an example, the determination is performed by the computation engine 220. In the present implementation, the computation engine 220 may determine a minimum distance between a first identifier associated with the first product and a second identifier associated with the second product. The distance may be a root mean square distance between the first identifier and the second identifier. The distance can also be, for example, a Manhattan distance or Hamming distance, etc. Further, the computation engine 220 may determine whether the unit product value of the first product with respect to a unit product value of the second product is within a pre-defined limit for variation. The unit product value of a product may be the unit selling amount of the product. In an embodiment, the pre-defined limit for variation is 25%. Therefore, only the products with their unit product value below or equal to 25% can be the pair of first and second products.

Further, at block 810, the method 800 includes obtaining demand curve data for the second product. In an example, the computation engine 220 may obtain the demand curve data from the database 204. As the second product is associated with sufficient product consumption data, the demand curve data for the second product may be obtained.

At block 812, the method 800 includes computing an optimal range of the product value for the first product. For example, the computation engine 220 may compute slope from a demand curve of the second product which provides an absolute change in product value of the second product with respect to an absolute change in sold units of the second product. As the demand curve typically provides a relationship between the number of units sold and the unit product value of a product or service. Therefore, optimal range of product value for the first product can be obtained based on the absolute change in product value of the second product with respect to absolute change in sold units of the second product.

The present subject matter therefore facilitates mapping products having insufficient product consumption data with the products having sufficient product consumption data. As a result, an optimal range of selling amount for products with insufficient product data may be obtained with accuracy.

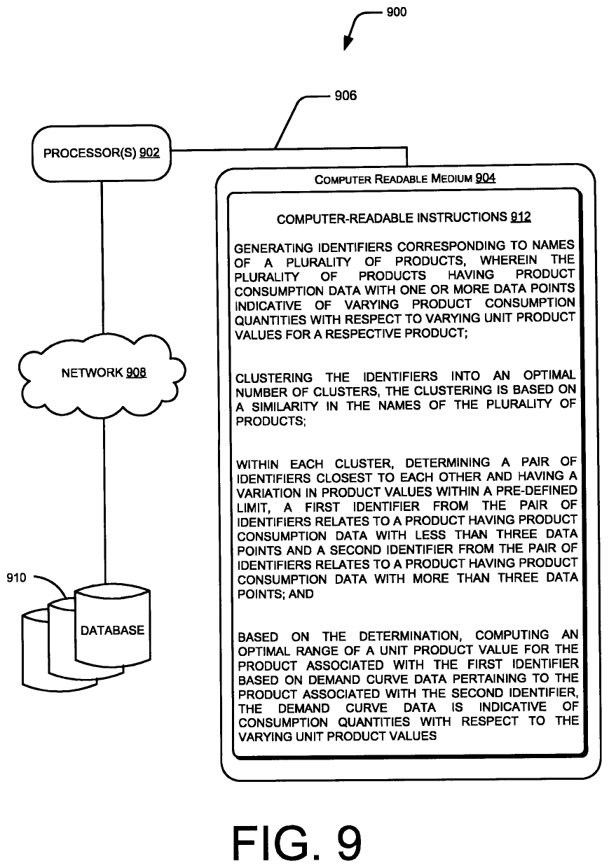

FIG. 9 illustrates a system environment 900 implementing a non-transitory computer readable medium for computing an optimal range of unit product values for products having insufficient product consumption data, according to an example. In an example, the system environment 900 includes processor(s) 902 communicatively coupled to a non-transitory computer readable medium 904 through a communication link 906. In an example, the processor(s) 902 may have one or more processing resources for fetching and executing computer-readable instructions from the non-transitory computer readable medium 904. The processor(s) 902 and the non-transitory computer readable medium 904 may be implemented, for example, in the system 100 (as has been described in conjunction with the preceding figures).

The non-transitory computer readable medium 904 may be, for example, an internal memory device or an external memory device. In an example implementation, the communication link 906 may be a network communication link. The processor(s) 902 may access the non-transitory computer-readable medium 904 through a network 908. The network 908 may be a single network or a combination of multiple networks and may use a variety of communication protocols. The processor(s) 902 and the non-transitory computer readable medium 904 may also be communicatively coupled to a data source 910 over the network 908. The data source 910 may include, for example, a database.

In an example implementation, the non-transitory computer readable medium 904 includes a set of computer readable instructions 912 which may be accessed by the processor(s) 902 through the communication link 906. Referring to FIG. 9, in an example, the non-transitory computer readable medium 904 includes instructions 912 that cause the processor(s) 902 to generate identifiers corresponding to names of a plurality of products. The plurality of products having product data with one or more data points. In an example, the data points indicate varying product consumption quantities with respect to varying unit product values for a respective product. In an example, the identifiers indicate numerical values associated with names of each of the plurality of products. Thus, the identifiers are generated for products, having less product data or more product data.

Further, the instructions 912 cause the processor(s) 902, to cluster the identifiers into an optimal number of clusters. In an example, the optimal number of clusters are identified based on an elbow method. Thereafter, based on a similarity in the names of the plurality of products, the identifiers are clustered into the optimal number of clusters. The clustering is performed using a k-means clustering technique. Thereafter, the instructions 912 cause the processor(s) 902 to determine a pair of identifiers within each cluster, which are closest to each other and have a variation in product value within a pre-defined limit. In an example, the pair of identifiers includes a first identifier and a second identifier. The first identifier relates to a product having insufficient product consumption data, i.e., less than three data points and the second identifier relates to a product having sufficient product consumption data, i.e., more than or equal to three data points. Thus, within each cluster pairing is done for the first identifiers with the second identifiers, based on a minimum distance between the identifiers and the price variation.

Further, the instructions 912 cause the processor(s) 902, to compute an optimal range of unit product value for the product associated with the first identifier. In an example, the optimal range of unit product value is computed based on demand curve data of the product associated with the second identifier. The demand curve data is indicative of product consumption quantities with respect to the varying unit product values. For example, a demand curve for a product having sufficient product consumption data, which is within the same cluster as a product having insufficient product consumption data, is obtained. Using the demand curve, a slope is determined to compute optimal range of unit product value for the product having insufficient product consumption data.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A method comprising:
generating, by a cluster generation engine, two or more clusters for a plurality of products, each of the two or more clusters having a respective set of products with similar names, the plurality of products having product consumption data with one or more data points indicative of varying product consumption quantities with respect to varying unit product values for a respective product;
within each cluster, for a first product having product consumption data with less than three data points, determining, by a computation engine, a second product that has product consumption data with more than three data points; and
based on the determination, computing, by the computation engine, an optimal range of a unit product value for the first product.

2. The method as claimed in claim 1, wherein the generating comprises determining identifiers based on name of each product from the plurality of products.

3. The method as claimed in claim 2, wherein the identifiers are determined using natural language processing techniques.

4. The method as claimed in claim 2, wherein the method comprises employing a k-means clustering technique for generating the two or more clusters.

5. The method as claimed in claim 2, wherein the determining the second product with respect to the first product is based on:
a minimum distance between an identifier of the first product and an identifier of the second product; and
a pre-defined limit for variation in a product value of the first product with respect to a product value of the second product.

6. The method as claimed in claim 5, wherein the pre-defined limit for variation in the product value of the first product with respect to the product value of the second product is about 25%.

7. The method as claimed in claim 1, wherein computing the optimal range of the unit product value for the first product comprises computing a slope from demand curve data of the second product.

8. A system comprising:
a processor;
a cluster generation engine, coupled to the processor, to:
determine a plurality of identifiers corresponding to names of a plurality of products, the plurality of products having product consumption data with one or more data points indicative of varying product consumption quantities with respect to varying unit product values for a respective product;
generate two or more clusters for the plurality of identifiers, each of the two or more clusters having a respective set of identifiers from amongst the plurality of identifiers, the set of identifiers relating to products with similar names;
a computation engine, coupled to the processor, to:
within each of the two or more clusters, for a first identifier associated with product consumption data having less than three data points, determine a second identifier associated with product consumption data having more than three data points, wherein the determination is based at least in part on a distance between the first identifier and the second identifier; and
based on the determination, compute an optimal range of a unit product value for a product associated with the first identifier.

9. The system as claimed in claim 8, wherein the plurality of identifiers is indicative of numerical values associated with the names of the plurality of products.

10. The system as claimed in claim 8, wherein the cluster generation engine uses natural language processing techniques to generate the plurality of identifiers.

11. The system as claimed in claim 8, wherein to generate the two or more clusters, the cluster generation engine is to determine an optimal number of clusters in which the plurality of identifiers is to be clustered.

12. The system as claimed in claim 11, wherein to determine the optimal number of clusters, the cluster generation engine is to define different numbers of clusters and calculate sum of a squared distance between an identifier and a centroid in each cluster.

13. The system as claimed in claim 8, wherein to determine the distance, the computing engine is to compute a root mean square distance between the first identifier and the second identifier.

14. The system as claimed in claim 8, wherein to determine the second identifier, the computation engine is to determine a pre-defined variation in a product value of a first product associated with the first identifier and a product value of a second product associated with the second identifier.

15. The system as claimed in claim 8, wherein to compute the optimal range of the unit product value for the first product, the computation engine is to compute a slope from demand curve data of the second product associated with the second identifier.

16. A non-transitory computer-readable medium having instructions stored thereon, the instructions, when executed by a processor, cause the processor to perform operations comprising:
generating identifiers corresponding to names of a plurality of products, wherein the plurality of products having product consumption data with one or more data points indicative of varying product consumption quantities with respect to varying unit product values for a respective product;
clustering the identifiers into an optimal number of clusters, the clustering is based on a similarity in the names of the plurality of products;
within each cluster, determining a pair of identifiers closest to each other and having a variation in product values within a pre-defined limit, a first identifier from the pair of identifiers relates to a product having product consumption data with less than three data points and a second identifier from the pair of identifiers relates to a product having product consumption data with more than three data points;
based on the determination, computing an optimal range of a unit product value for the product associated with the first identifier based on demand curve data pertaining to the product associated with the second identifier, the demand curve data is indicative of product consumption quantities with respect to the varying unit product values.

17. The non-transitory computer-readable medium as claimed in claim 16, wherein generating identifiers comprises:
converting names of each of the plurality of products in lowercase;
removing punctuation and stopwords from the names of each of the plurality of products; and
transforming the names of each of the plurality of products into the identifiers.

18. The non-transitory computer-readable medium as claimed in claim 16, wherein the optimal number of clusters is determined using an elbow method.

19. The non-transitory computer-readable medium as claimed in claim 16, wherein the clustering is performed using a k-means technique.

20. The non-transitory computer-readable medium as claimed in claim 16, wherein computing the optimal range of the unit product value for the product associated with the first identifier comprises computing a slope from the demand curve data pertaining to the product associated with the second identifier.
